(19) United States
(12) Patent Application Publication
(10) Pub. No.: US 2015/0028988 A1
(43) Pub. Date: Jan. 29, 2015

(54) LAMINATED COIL

(71) Applicant: MURATA MANUFACTURING CO., LTD., Kyoto (JP)

(72) Inventors: Kouji YAMAUCHI, Nagaokakyo-shi (JP); Mitsuru ODAHARA, Nagaokakyo-shi (JP)

(73) Assignee: MURATA MANUFACTURING CO., LTD., Kyoto (JP)

(21) Appl. No.: 14/320,877

(22) Filed: Jul. 1, 2014

(30) Foreign Application Priority Data
Jul. 29, 2013 (JP) 2013-156446

(51) Int. Cl. H01F 27/28

(52) U.S. Cl. CPC H01F 27/2804; H01F 2027/2809
USPC 336/200

(57) ABSTRACT

A laminated coil having; a laminate body including a plurality of insulating layers laminated horizontally; and a coil located in the laminate body off-center in an upper portion of the laminate body and including a plurality of coil conductors connected through via conductors piercing the insulating layers. The plurality of coil conductors includes a first coil conductor and a second coil conductor. A cross-sectional area of the second coil conductor is less than a cross-sectional area of the first coil conductor. The second coil conductor is a lowermost coil conductor of the plurality of the coil conductors. A lower surface of the laminate body is a mounting surface.

### CROSS REFERENCE TO RELATED APPLICATIONS

This application claims benefit of priority to Japanese Patent Application No. 2013-156446 filed Jul. 29, 2013, the entire content of which is incorporated herein by reference.

### TECHNICAL FIELD

The present disclosure relates to a laminated coil, and more particularly to a laminated coil including a coil located in a laminate body off-center in an upper portion of a laminate body.

### BACKGROUND

An example of conventional laminated coils of this kind is a chip inductor disclosed by Japanese Patent Laid-Open Publication No. 2005-45103. In a laminated coil of this kind, a coil is embedded in a laminate body consisting of laminated insulating layers. The lower surface of the laminate body serves as a mounting surface when the laminated coil is mounted on a printed wiring board. In the laminated coil, in order to prevent a magnetic flux generated by the coil from interlinking with a conductive pattern on the printed wiring board, the coil is located in the laminate body off-center and specifically located in an upper portion of the laminate body.

However, because the coil is located in the laminated body off-center, during sintering of the laminated coil, the shrinking percentage of the portion including the coil and the shrinking percentage of the portion not including the coil vary drastically. With the drastic variation in shrinking percentage, too much stress occurs between the insulating layers around the border between the portion including the coil and the portion not including the coil, thereby possibly causing delamination.

### SUMMARY

An object of the present disclosure is to provide a laminated coil having a coil located in a laminate body off-center in an upper portion of the laminate body and diminishing the risk of having delamination at the border between the portion including the coil and the portion not including the coil.

A laminated coil according to an embodiment of the present disclosure comprises: a laminate body including a plurality of insulating layers laminated horizontally; and a coil located in the laminate body off-center in an upper portion of the laminate body and including a plurality of coil conductors connected through via conductors piercing the insulating layers. In the laminated coil, the plurality of coil conductors includes a first coil conductor and a second coil conductor. A cross-sectional area of the second coil conductor, which is an area of a surface made by cutting the second coil conductor in a direction perpendicular to a direction in which the second coil conductor extends, is less than a cross-sectional area of the first coil conductor, which is an area of a surface made by cutting the first coil conductor in a direction perpendicular to a direction in which the first coil conductor extends. The second coil conductor is a lowermost coil conductor of the plurality of coil conductors. A lower surface of the laminate body is a mounting surface.

In the laminated coil according to the embodiment of the present disclosure, the cross-sectional area of the second coil conductor is less than the cross-sectional area of the first coil conductor, and the second coil conductor is the lowermost coil conductor of the plurality of coil conductors included in the laminated coil. In other words, the cross-sectional area of the lowermost coil conductor is less than any of the other coil conductors located above. Therefore, in the laminated coil, the shrinking percentage varies gradually around the border between the portion including the coil and the portion not including the coil. Consequently, the stress applied to the insulating layers around the border between the portion including the coil and the portion not including the coil is weakened, and the risk of delamination can be diminished.

### BRIEF DESCRIPTION OF THE DRAWINGS

FIG. 1 is a perspective view of a laminated coil according to an embodiment of the present disclosure.

FIG. 2 is an exploded perspective view of the laminated coil according to the embodiment of the present disclosure.

FIG. 3 is a sectional view of the laminated coil shown by FIG. 1, cut along the line 3-3 shown in FIG. 1.

FIG. 4 is a sectional view of a laminated coil according to a first modification.

FIG. 5 is a sectional view of a laminated coil according to a second modification.

FIG. 6 is a sectional view of a laminated coil according to a third modification.

FIG. 7 is a sectional view of a laminated coil according to a fourth modification.

FIG. 8 is an exploded perspective view of a laminated coil according to a fifth modification.

FIG. 9 is a sectional view of the laminated coil according to the fifth modification.

FIG. 10 is a sectional view of a laminated coil according to a sixth modification.

### DETAILED DESCRIPTION

A laminated coil according to an embodiment and a manufacturing method of the laminated coil are hereinafter described.

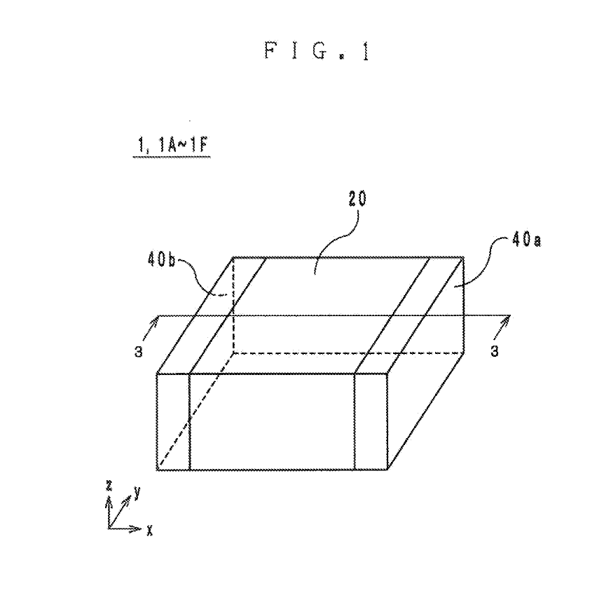

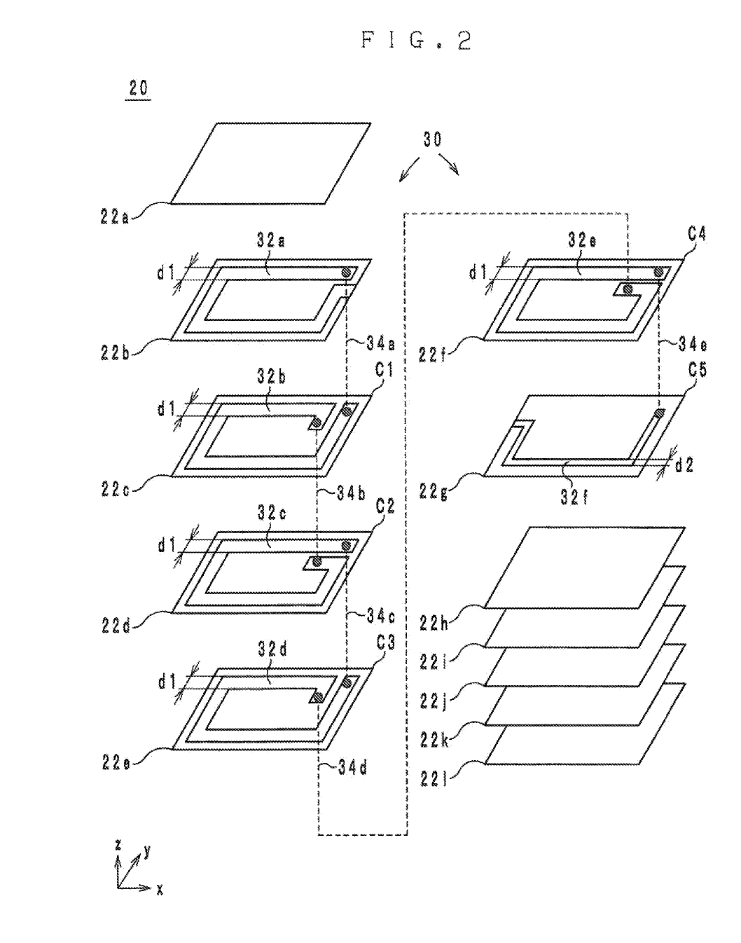

### Structure of Laminated Coil; See FIGS. 1 and 2

The structure of a laminated coil 1 according to an embodiment of the present disclosure is described with reference to the drawings. A direction of lamination of the laminated coil 1 is defined as a z-axis direction. When viewed from the z-axis direction, a direction in parallel to long sides of the laminated coil 1 is defined as an x-axis direction, and a direction in parallel to short sides of the laminated coil 1 is defined as a y-axis direction. The x-axis, y-axis and z-axis are perpendicular to one another.

The laminated coil 1 comprises a laminate body 20, a coil 30 and external electrodes 40a and 40b. The laminated coil 1 is, as shown by FIG. 1, in the shape of a rectangular parallelepiped.

The laminate body 20 comprises insulating layers 22a through 221 laminated in the z-axis direction in this order from a positive side. Each of the insulating layers 22a through 221 is rectangular when viewed from the z-axis direction. Accordingly, the laminate body 20 constructed by lamination of the insulating layers 22a through 221 is, as shown by FIG. 1, a rectangular parallelepiped. When the laminated coil 1 is mounted on a printed wiring board, the surface of the laminate body 20 located on a negative side in the z-axis direction serves as a mounting surface to face the printed wiring board. With regard to each of the insulating layers 22a through 221, in the following paragraphs, the surface on the positive side in the z-axis direction is referred to as an upper surface, and the surface on the negative side in the z-axis direction is referred to as a lower surface. As the material for the insulating layers 22a through 221, a magnetic material (for example, ferrite) or a non-magnetic material (for example, glass, alumina or a compound thereof) is used.

As shown in FIG. 1, the external electrode 40a is arranged to cover a surface of the laminate body 20 located on a positive side in the x-axis direction and parts of the surrounding surfaces thereof. The external electrode 40b is arranged to cover a surface of the laminate body 20 located on a negative side in the x-axis direction and parts of the surrounding surfaces thereof. As the material for the external electrodes 40a and 40b, a conductive material such as Au, Ag, Pd, Cu, Ni or the like is used.

The coil 30 is, as shown in FIG. 2, located inside the laminate body 20, and comprises coil conductors 32a through 32f and via conductors 34a through 34e. The coil 30 is spiral, and the axis of the spiral is parallel to the z-axis. In other words, the coil 30 goes around the axis as it goes in the direction of lamination. As the material for the coil 30, a conductive material such as Au, Ag, Pd, Cu, Ni or the like is used.

The coil conductor 32a is a linear conductor provided on the upper surface of the insulating layer 22b. The coil conductor 32a extends along the outer edges of the insulating layer 22b at both of the positive and negative ends in the x-axis direction and at both of the positive and negative ends in the y-axis direction, and accordingly, the coil conductor 32a is in the shape of a square when viewed from the direction of lamination. A first end of the coil conductor 32a is exposed on the surface of the laminate body 20 through the outer edge of the insulating layer 22b at the positive end in the x-axis direction, and the first end of the coil conductor 32a is connected to the external electrode 40a. A second end of the coil conductor 32a is located near the corner of the insulating layer 22b made by the outer edge at the positive end in the x-axis direction and the outer edge at the positive end in the y-axis direction, and the second end is connected to the via conductor 34a piercing the insulating layer 22b in the z-axis direction.

The coil conductor 32b is a linear conductor provided on the upper surface of the insulating layer 22c. The coil conductor 32b extends along the outer edges of the insulating layer 22c at both of the positive and negative ends in the x-axis direction and at both of the positive and negative ends in the y-axis direction, and accordingly, the coil conductor 32b is in the shape of a square when viewed from the direction of lamination. A first end of the coil conductor 32b is located near a corner C1 of the insulating layer 22c made by the outer edge at the positive end in the x-axis direction and the outer edge at the positive end in the y-axis direction, and the first end of the coil conductor 32b is connected to the via conductor 34a. A second end of the coil conductor 32b is located near the corner C1 but closer to the center of the insulating layer 22c than the first end of the coil conductor 32b. The second end of the coil conductor 32b is connected to a via conductor 34b piercing the insulating layer 22c in the z-axis direction.

The coil conductor 32c is a linear conductor provided on the upper surface of the insulating layer 22d. The coil conductor 32c extends along the outer edges of the insulating layer 22d at both of the positive and negative ends in the x-axis direction and at both of the positive and negative ends in the y-axis direction, and accordingly, the coil conductor 32c is in the shape of a square when viewed from the direction of lamination. A first end of the coil conductor 32c is located near a corner C2 of the insulating layer 22d made by the outer edge at the positive end in the x-axis direction and the outer edge at the positive end in the y-axis direction, and the first end of the coil conductor 32c is connected to the via conductor 34b. A second end of the coil conductor 32c is located closer to the corner C2 of the insulating layer 22d than the first end of the coil conductor 32c. The second end of the coil conductor 32c is connected to a via conductor 34c piercing the insulating layer 22d in the z-axis direction.

The coil conductor 32d is a linear conductor provided on the upper surface of the insulating layer 22e. The coil conductor 32d extends along the outer edges of the insulating layer 22e at both the positive and negative ends in the x-axis direction and at both of the positive and negative ends in the y-axis direction, and accordingly, the coil conductor 32d is in the shape of a square when viewed from the direction of lamination. A first end of the coil conductor 32d is located near a corner C3 of the insulating layer 22e made by the outer edge at the positive end in the x-axis direction and the outer edge at the positive end in the y-axis direction, and the first end of the coil conductor 32d is connected to the via conductor 34c. A second end of the coil conductor 32d is located near the corner C3 but closer to the center of the insulating layer 22e than the first end of the coil conductor 32d. The second end of the coil conductor 32d is connected to a via conductor 34d piercing the insulating layer 22e in the z-axis direction.

The coil conductor 32e is a linear conductor provided on the upper surface of the insulating layer 22f. The coil conductor 32e extends along the outer edges of the insulating layer 22f at both of the positive and negative ends in the x-axis direction and at both of the positive and negative ends in the y-axis direction, and accordingly, the coil conductor 32e is in the shape of a square when viewed from the direction of lamination. A first end of the coil conductor 32e is located near a corner C4 of the insulating layer 22f made by the outer edge at the positive end in the x-axis direction and the outer edge at the positive end in the y-axis direction, and the first end of the coil conductor 32e is connected to the via conductor 34d. A second end of the coil conductor 32e is located closer to the corner C4 than the first end of the coil conductor 32e. The second end of the coil conductor 32e is connected to a via conductor 34e piercing the insulating layer 22f in the z-axis direction.

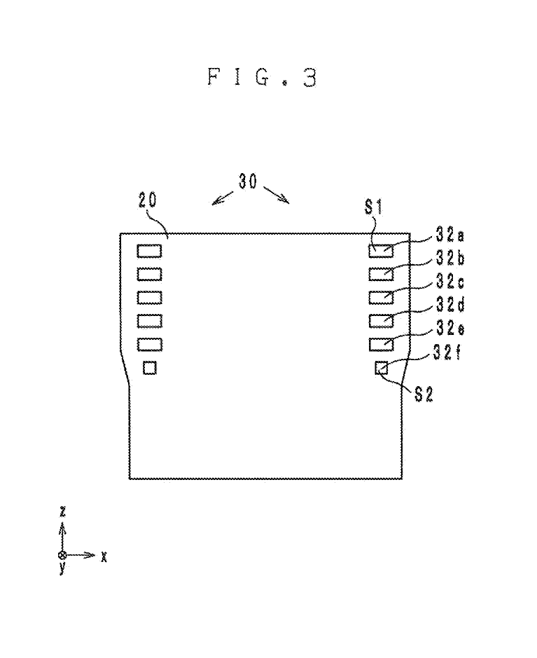

The coil conductor 32f is a linear conductor provided on the upper surface of the insulating layer 22g. Each of the coil conductors 32a through 32e has a line width d1, and the coil conductor 32f has a line width d2 less than d1. The coil conductor 32f has a thickness substantially equal to the thickness of each of the coil conductors 32a through 32e. As shown in FIG. 3, each of the coil conductors 32a through 32e has an area S1 of a cross section, which is made by cutting each of the coil conductors 32a through 32e in a direction perpendicular to the extending direction thereof. The coil conductor 32f has an area S2 in a cross section, which is made by cutting the coil conductor 32f in a direction perpendicular to a direction in which the coil conductor 32f extends, and the area S2 is less than S1. As shown in FIG. 2, the coil conductor 32f extends along the outer edges of the insulating layer 22g at both of the positive and negative ends in the x-axis direction and at the negative end in the y-axis direction, and accordingly, the coil conductor 32f is substantially U-shaped when viewed from the direction of lamination. A first end of the coil conductor 32f is located near a corner C5 of the insulating layer 22g made by the outer edge at the positive end in the x-axis direction and the outer edge at the positive end in the y-axis direction, and the first end of the coil conductor 32f is connected to the via conductor 34e. A second end of the coil conductor 32f is exposed on a surface of the laminate body 20 through the outer edge of the insulating layer 22g at the negative end in the x-axis direction, and the second end of the conductor coil 32f is connected to the external electrode 40b.

In the laminated coil 1 structured above, the center of the coil 30 composed of the coil conductors 32a through 32f and the via conductors 34a through 34e is located in the laminate body 20 off-center, that is, located in the positive portion in the z-axis direction (in the upper portion) of the laminate body 20. Therefore, the distance between the upper surface of the laminate body 20 and the coil conductor 32a is shorter than the distance between the lower surface of the laminate body 20 and the coil conductor 32f.

### Manufacturing Method

A method for manufacturing laminated coils according to the present disclosure is hereinafter described. A direction of lamination of green sheets is referred to as a z-axis direction. A direction parallel to the longer sides of laminated coils 1 to be manufactured by the method is referred to as an x-axis direction, and a direction parallel to the shorter sides of the laminated coils 1 is referred to as a y-axis.

First, ceramic green sheets to be used as the insulating layers 22a through 22l are prepared. Specifically, predetermined weights of constituents, mainly, BaO, Al₂O₃, SiO₂, etc. are prepared and mixed together, and the mixture is wet-milled, whereby slurry of the mixture is obtained. The slurry is calcined at temperatures within 850 degrees C. to 950 degrees C., whereby calcined powder (porcelain composition powder) is obtained. In the same way, predetermined weights of constituents, mainly, B₂O₃, K₂O, SiO₂, etc. are prepared and mixed together, and the mixture is wet-milled, whereby slurry of the mixture is obtained. The slurry is calcined at temperatures within 850 degrees C. to 950 degrees C., whereby calcined powder (borosilicate glass powder) is obtained.

The calcined powder with a predetermined weight is prepared, and a binder (vinyl acetate, water-soluble acrylic or the like), a plasticizer, a wetter and a dispersant are added and mixed with the calcined powder in a ball mill. Thereafter, the mixture is defoamed by decompression. The resultant ceramic slurry is spread on a carrier film to be made into a sheet by a doctor blade method, and the sheet is dried. In this way, green sheets to be used as the insulating layers 22a through 22l are prepared.

Next, the green sheets to be used as the insulating layers 22b through 22f are irradiated with a laser beam, whereby via holes are made in the green sheets. Thereafter, conductive paste consisting mainly of Au, Ag, Pd, Cu, Ni or the like is filled in the via holes, whereby the via conductors 34a through 34e are formed. The step of filling the conductive paste in the via holes may be carried out simultaneously with a step of forming the coil conductors 32a through 32f, which will be described later.

After the formation of the via holes or the formation of the via conductors, conductive paste consisting mainly of Au, Ag, Pd, Cu, Ni or the like is applied on the upper surface of each of the green sheets to be used as the insulating layers 22b through 22g by screen printing. Thereby, the coil conductors 32a through 32f are formed.

Next, the green sheets to be used as the insulating layers 22a through 22l are laminated in this order and pressure-bonded together, whereby an unsintered mother laminate is obtained. The unsintered mother laminate is pressed by isostatic pressing and really pressure-bonded.

After the real pressure bonding, the unsintered mother laminate is cut by a cutting blade into laminate bodies 20 of a specified size. The unsintered laminate bodies 20 are subjected to debinding treatment and sintering. The debinding treatment is carried out, for example, in a hypoxic atmosphere at a temperature of 500 degrees C. for two hours. The sintering is carried out, for example, at temperatures within 800 degrees C. to 900 degrees C. for two hours and a half.

After the sintering, the external electrodes 40a and 40b are formed. First, electrode paste consisting mainly of Ag is applied to the surfaces of the laminate bodies 20, and the applied electrode paste is baked at a temperature around 800 degrees C. for an hour. Thereby, underlying electrodes of the external electrodes 40a and 40b are formed.

Finally, the underlying electrodes are plated with Ni/Sn. Thereby, the external electrodes 40a and 40b are formed. Through the processes above, the laminated coil 1 is produced.

### Advantageous Effects; See FIGS. 2 and 3

The laminated coil 1 according to the embodiment above diminishes the risk of delamination for the following reason. The shrinking percentage of the insulating layers 22a through 22l during the sintering is greater than the shrinking percentage of the coil conductors 32a through 32f during the sintering. Accordingly, a first portion of the laminate body 20 not including the coil 30 shrinks to a greater degree than a second portion of the laminate body 20 including the coil 30. In the laminated coil 1, as shown in FIG. 3, the cross-sectional area S2 of the coil conductor 32f located near the border between the first portion not including the coil 30 and the second portion including the coil 30 is smaller than the cross-sectional area S1 of each of the coil conductors 32a through 32e. Thus, a relatively large amount of material for the coil conductors is included in the first portion, and relatively a small amount of material for the coil conductors is located near the border between the first portion and the second portion. No material for the coil conductors is included in the second portion. Hence, among the first portion, the portion around the border between the first portion and the second portion, and the second portion, the latterly recited portion includes a smaller amount of conductive material and accordingly shrinks to a greater degree than the previously recited portions. In this structure, the variation in shrinking percentage between the portion including the coil 30 and the portion not including the coil 30 is not drastic. Consequently, the stress applied to the insulating layers around the border between the portion including the coil 30 and the portion not including the coil 30 can be weakened, and the risk of delamination can be diminished.

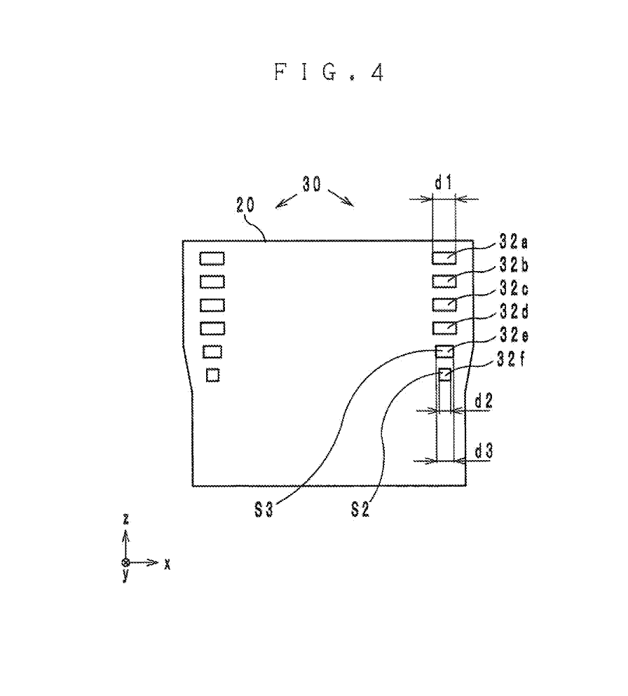

### First Modification; See FIG. 4

A laminated coil 1A according to a first modification is different from the laminated coil 1 in the line width of the coil conductor 32e. Specifically, in the laminated coil 1A, as shown in FIG. 4, the coil conductor 32e has a line width d3 between the line width d1 of the coil conductors 32a through 32d and the line width d2 of the coil conductor 32f. Accordingly, in the laminated coil 1A, between the two vertically adjacent coil conductors 32e and 32f (between the coil conductors 32e and 32f adjacent to each other in the z-axis direction) that are in the negative z-axis portion of the coil 30 (in the lower portion of the coil 30), the cross-sectional area S2 of the coil conductor 32f located on the negative side in the z-axis direction is smaller than the cross-sectional area S3 of the coil conductor 32e located on the positive side in the z-axis direction.

The negative z-axis portion of the coil 30 means a portion of the coil 30 is within a certain range from the negative end in the z-axis direction (the lower end) of the coil 30. According to the first modification, the negative z-axis portion of the coil 30 corresponds to the portion where the lowermost two coil conductors 32e and 32f are located. However, the negative z-axis portion of the coil 30 is not limited to this portion and may be the portion where the lowermost coil conductor is located or the portion where the lowermost three or more coil conductors are located.

In the laminated coil 1A having the structure above, around the border between the portion including the coil 30 and the portion not including the coil 30, the shrinking percentage varies more gradually than that in the laminated coil 1. Consequently, the stress applied to the insulating layers around the border between the portion including the coil 30 and the portion not including the coil 30 can be more weakened, and the risk of delamination can be diminished. There is no other difference in structure between the laminated coil 1A and the laminated coil 1. Therefore, the descriptions of the components of the laminated coil 1 other than the description of the line width of the coil conductor 32e apply to the components of the laminated coil 1A.

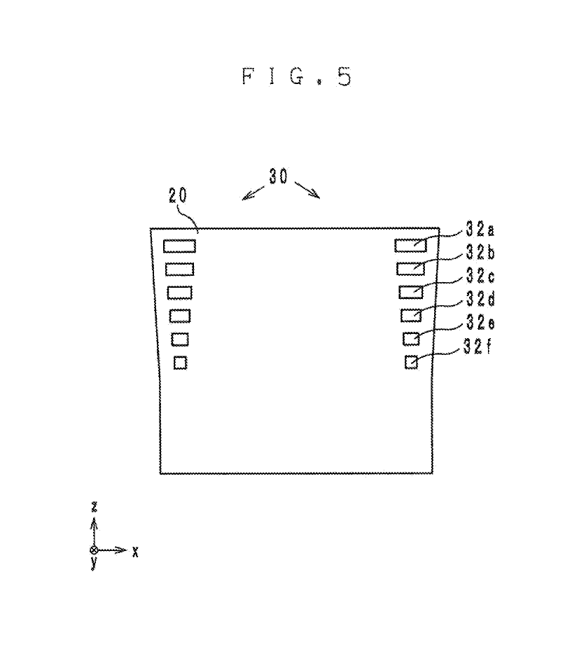

### Second Modification; See FIG. 5

A laminated coil 1B according to a second modification is different from the laminated coil 1 in the line widths of the coil conductors 32a through 32f. Specifically, in the laminated coil 1B, as shown in FIG. 5, among the coil conductors 32a through 32f located in this order from the positive side to the negative side in the z-axis direction, a coil conductor located farther on the negative side has a smaller line width than a coil conductor located farther on the positive side. Accordingly, in the laminated coil 1B, between two vertically adjacent coil conductors (between two coil conductors adjacent to each other in the z-axis direction), the cross-sectional area of the coil conductor located on the negative side in the z-axis direction is smaller than the cross-sectional area of the coil conductor located on the positive side in the z-axis direction.

In the laminated coil 1B having the structure above, from the portion including the coil 30 to the portion not including the coil 30, the shrinking percentage varies more gradually than that in the laminated coil 1. Consequently, the stress applied to the insulating layers around the border between the portion including the coil 30 and the portion not including the coil 30 can be more weakened, and the risk of delamination can be diminished. There is no other difference in structure between the laminated coil 1B and the laminated coil 1. Therefore, the descriptions of the components of the laminated coil 1 other than the description of the line widths of the coil conductors 32a through 32f apply to the components of the laminated coil 1B.

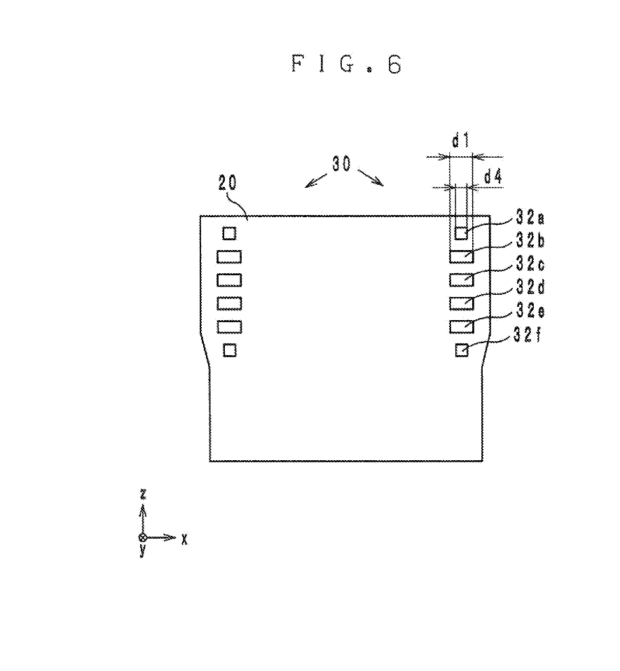

### Third Modification; See FIG. 6

A laminated coil 1C according to a third modification is different from the laminated coil 1 in the line width of the coil conductor 32a.

Specifically, in the laminated coil 1C, as shown in FIG. 6, the coil conductor 32a has a line width d4 smaller than the line width d1 of each of the coil conductors 32b through 32e.

In the laminated coil 1C having the structure above, floating capacitances induced between the external electrode 40a and the coil 30 and between the external electrode 40b and the coil 30 can be reduced compared with the laminated coil 1. In the laminated coil 1C, also, as in the laminated coil 1, the risk of delamination around the border between the portion including the coil 30 and the portion not including the coil 30 can be diminished. There is no other difference in structure between the laminated coil 1C and the laminated coil 1. Therefore, the descriptions of the components of the laminated coil 1 other than the description of the line widths of the coil conductor 32a apply to the components of the laminated coil 1C.

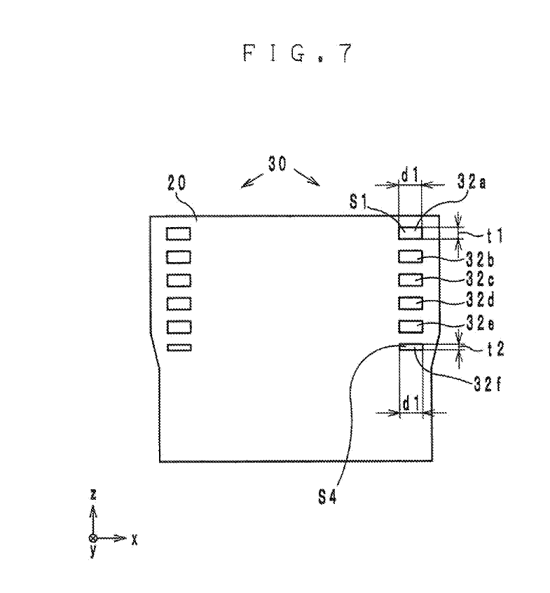

### Fourth Modification; See FIG. 7

A laminated coil 1D according to a fourth modification is different from the laminated coil 1 in the line width and the thickness of the coil conductor 32f. Specifically, in the laminated coil 1D, as shown by FIG. 7, the coil conductor 32f has a line width equal to the line width d1 of each of the coil conductors 32a through 32e. However, the coil conductor 32f has a thickness t2 smaller than the thickness t1 of each of the coil conductors 32a through 32e.

In the laminated coil 1D having the structure above, since the thickness t2 of the coil conductor 32f is smaller than the thickness t1 of each of the coil conductors 32a through 32e, the coil conductor 32f has a cross-sectional area S4 smaller than the cross-sectional area 51 of each of the coil conductors 32a through 32e. In the laminated coil 1D, therefore, around the border between the portion including the coil 30 and the portion not including the coil 30, the shrinking percentage varies gradually. Consequently, the stress applied to the insulating layers around the border between the portion including the coil 30 and the portion not including the coil 30 can be weakened, and the risk of delamination can be diminished. There is no other difference in structure between the laminated coil 1D and the laminated coil 1. Therefore, the descriptions of the components of the laminated coil 1 other than the description of the line width and the thickness of the coil conductor 32f apply to the components of the laminated coil 1D.

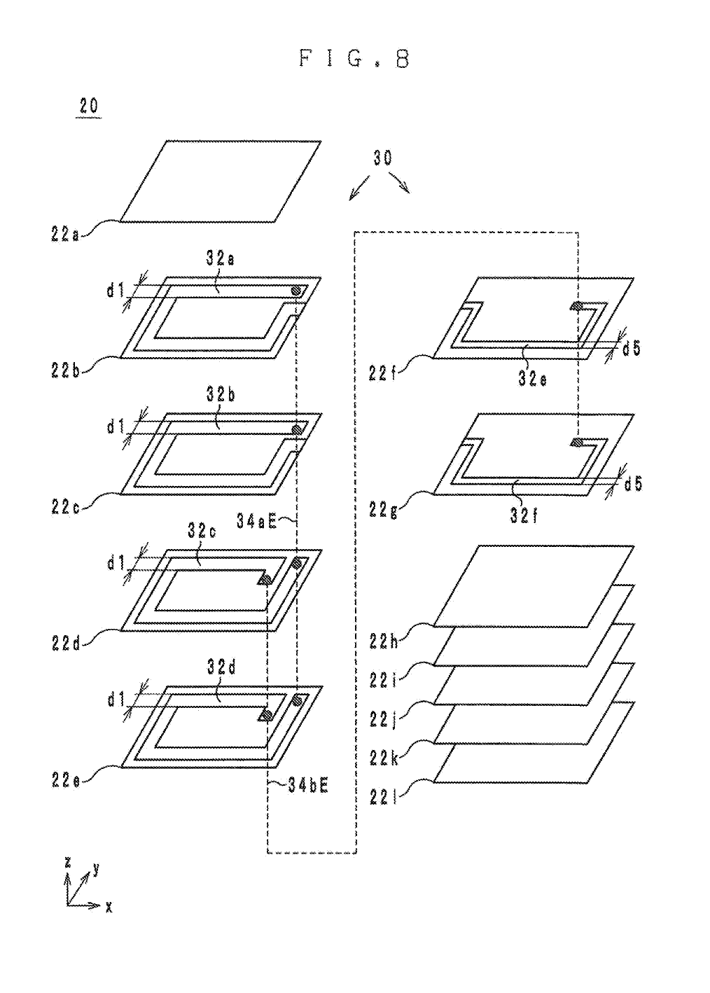

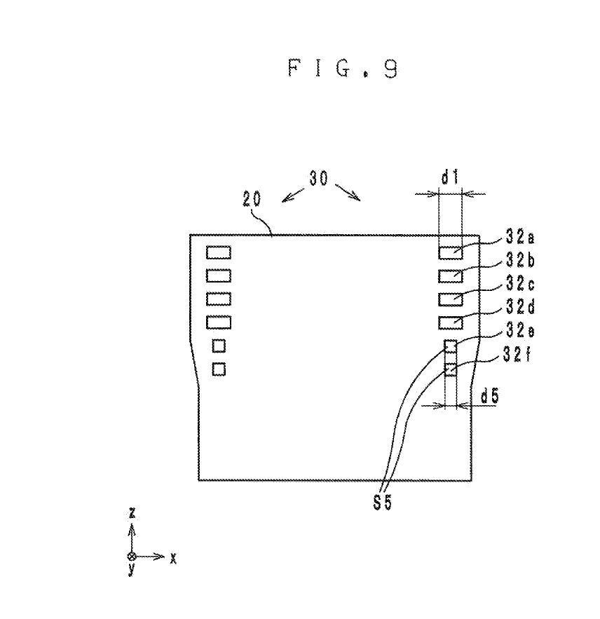

### Fifth Modification; See FIGS. 8 and 9

A laminated coil 1E according to a fifth modification is different from the laminated coil 1 in the shapes of the coil conductors 32a through 32f and the relation of connection among them. A specific description is given below.

In the laminated coil 1E, as shown in FIG. 8, the coil conductors 32a and 32b have the same shape and are connected in parallel. Also, the coil conductors 32a and 32b are connected to the external electrode 40a.

In the laminated coil 1E, the coil conductors 32c and 32d have the same shape as the coil conductor 32b in the laminated coil 1. The coil conductors 32c and 32d in the laminated coil 1E are connected in parallel, and are connected in series to the coil conductors 32a and 32b through a via conductor 34aE.

The coil conductors 32e and 32f in the laminated coil 1E have substantially the same shape as the coil conductor 32f in the laminated coil 1 except that each of the coil conductors 32e and 32f in the laminated coil 1E has an end portion bent in the negative direction on the x-axis. In the laminated coil 1E, the coil conductors 32e and 32f are connected in parallel. A first end of the coil conductor 32e and a first end of the coil conductor 32f are connected in series to the coil conductors 32c and 32d through a via conductor 32bE, and a second end of the coil conductor 32e and a second end of the coil conductor 32f are connected to the external electrode 40b. Each of the coil conductors 32e and 32f has a line width d5 smaller than the line width d1 of each of the coil conductors 32a through 32d. Accordingly, in the laminated coil 1E, between the two vertically adjacent coil conductors 32e and 32f (between the coil conductors 32e and 32f adjacent to each other in the z-axis direction) that are in the negative z-axis portion of the coil 30 (in the lower portion of the coil 30), the cross-sectional area S5 of the coil conductor 32f located relatively on the negative side in the z-axis direction is equal to the cross-sectional area S5 of the coil conductor 32e located relatively in the positive side in the z-axis direction. In other words, the cross-sectional area of the coil conductor 32f is less than or equal to the cross-sectional area of the coil conductor 32e.

The laminated coil 1E having the structure above is a laminated coil having what is called a multiple-winding structure. Compared with the laminated coil 1, the laminated coil 1E has more coil conductors with smaller line widths. In the laminated coil 1E, therefore, around the border between the portion including the coil 30 and the portion not including the coil 30, the shrinking percentage varies more gradually. Consequently, the stress applied to the insulating layers around the border between the portion including the coil 30 and the portion not including the coil 30 can be weakened, and the risk of delamination can be diminished. There is no other difference in structure between the laminated coil 1E and the laminated coil 1. Therefore, the descriptions of the components of the laminated coil 1 other than the descriptions of the shapes of the coil conductors 32b through 32f and the relation of connection among them apply to the components of the laminated coil 1E.

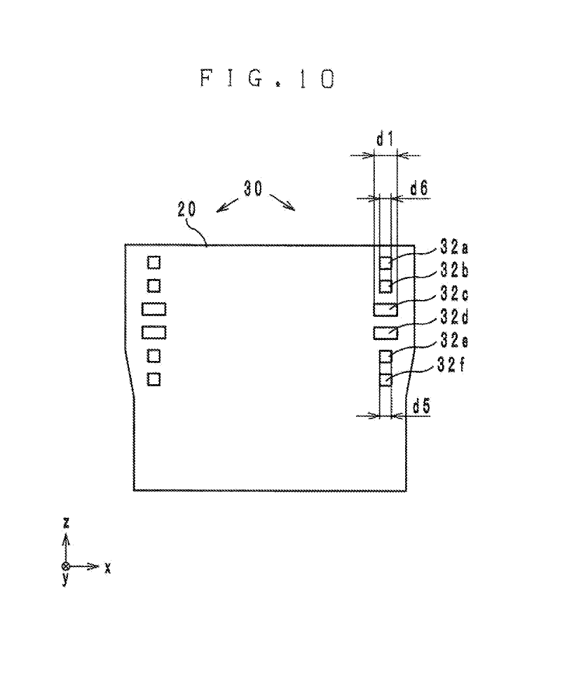

### Sixth Modification; See FIG. 10

A laminated coil 1F according to a sixth modification is different from the laminated coil 1E according to the fifth modification in the line widths of the coil conductors 32a and 32b. Specifically, in the laminated coil 1F, as shown in FIG. 10, each of the coil conductors 32a and 32b has a line width d6 smaller than the line width d1 of each of the coil conductors 32c and 32d.

In the laminated coil 1F having the structure above, floating capacitances induced between the external electrode 40a and the coil 30 and between the external electrode 40b and the coil 30 can be reduced compared with the laminated coil 1E. In the laminated coil 1F, also, as in the laminated coil 1E, the risk of delamination around the border between the portion including the coil 30 and the portion not including the coil 30 can be diminished. There is no other difference in structure between the laminated coil 1F and the laminated coil 1E. Therefore, the descriptions of the components of the laminated coil 1E other than the description of the line widths of the coil conductors 32a and 32b apply to the components of the laminated coil 1F.

### Other Embodiments

Laminated coils according to the present disclosure are not limited to the laminated coils described above. For example, the line width of the coil conductor 32b may be smaller than the line width of the coil conductor 32a, and the line width of the coil conductor 32c may be equal to the line width of the coil conductor 32a. In sum, it is only necessary that the lowermost coil conductor has a line width smaller than any of the other coil conductors located above. Also, a laminated coil may include both a coil conductor having a smaller line width and accordingly having a smaller cross-sectional area and a coil conductor having a smaller thickness and accordingly having a smaller cross-sectional area. In other words, it is possible to combine the embodiment and modifications described above. Further, the cross-sectional area of a coil conductor may be reduced by reducing both the line width and the thickness of the coil conductor.

Although the present disclosure has been described in connection with the preferred embodiments above, it is to be noted that various changes and modifications may be obvious to persons skilled in the art. Such changes and modifications are to be understood as being within the scope of the disclosure.

What is claimed is:

1. A laminated coil comprising:
a laminate body including a plurality of insulating layers laminated horizontally; and
a coil located in the laminate body off-center in an upper portion of the laminate body and including a plurality of coil conductors connected through via conductors piercing the insulating layers,
wherein the plurality of coil conductors include a first coil conductor and a second coil conductor;
wherein a cross-sectional area of the second coil conductor, which is an area of a surface made by cutting the second coil conductor in a direction perpendicular to a direction in which the second coil conductor extends, is less than a cross-sectional area of the first coil conductor, which is an area of a surface made by cutting the first coil conductor in a direction perpendicular to a direction in which the first coil conductor extends;
wherein the second coil conductor is a lowermost coil conductor of the plurality of coil conductors; and
wherein a lower surface of the laminate body is a mounting surface.

2. The laminated coil according to claim 1,
wherein between two vertically adjacent coil conductors of the plurality of coil conductors located in a lower portion of the coil, a cross-sectional area of the lower coil conductor of the two vertically adjacent coil conductors, which is an area of a surface made by cutting the lower coil conductor in a direction perpendicular to a direction in which the lower coil conductor extends, is less than or equal to a cross-sectional area of the upper coil conductor of the two vertically adjacent coil conductors, which is an area of a surface made by cutting the upper coil conductor in a direction perpendicular to a direction in which the upper coil conductor extends.

3. The laminated coil according to claim 1,
wherein between two vertically adjacent coil conductors of the plurality of coil conductors located in a lower portion of the coil, a cross-sectional area of the lower coil conductor of the two vertically adjacent coil conductors, which is an area of a surface made by cutting the lower coil conductor in a direction perpendicular to a direction in which the lower coil conductor extends, is less than a cross-sectional area of the upper coil conductor of the two vertically adjacent coil conductors, which is an area of a surface made by cutting the upper coil conductor in a direction perpendicular to a direction in which the upper coil conductor extends.

4. The laminated coil according to claim 1,
wherein between two vertically adjacent coil conductors of the plurality of coil conductors, a cross-sectional area of the lower coil conductor of the two vertically adjacent coil conductors, which is an area of a surface made by cutting the lower coil conductor in a direction perpendicular to a direction in which the lower coil conductor extends, is less than a cross-sectional area of the upper coil conductor of the two vertically adjacent coil conductors, which is an area of a surface made by cutting the upper coil conductor in a direction perpendicular to a direction in which the upper coil conductor extends.

5. The laminated coil according to claim 1,
wherein a line width of the second coil conductor is less than a line width of the first coil conductor.

6. The laminated coil according to claim 1,
wherein a thickness of the second coil conductor is less than a thickness of the first coil conductor.
